(19) United States
(12) Patent Application Publication
(10) Pub. No.: US 2013/0188297 A1
(43) Pub. Date: Jul. 25, 2013

(54) NEUTRAL BUS FOR A NEUTRAL BAR AND ELECTRICAL DISTRIBUTION PANEL INCLUDING THE SAME

(71) Applicant: MICHAEL J. RANTA, Morton, IL (US)

(72) Inventor: MICHAEL J. RANTA, Morton, IL (US)

(21) Appl. No.: 13/356,900

(22) Filed: Jan. 24, 2012

(51) Int. Cl. H01B 5/02; H02G 5/00

(52) U.S. Cl. 361/637; 174/68.2

(57) ABSTRACT

A neutral bus is for a neutral bar including a plurality of openings and a plurality of corresponding fasteners. The neutral bus includes an elongated conductor having a first end and an opposite second end, and an insulator substantially covering the elongated conductor. At least one of the first end and the opposite second end is made of a flat material, which is curled to form a curved shape that is structured to be inserted and fastened in one of the openings of the neutral bar.

### BACKGROUND

1. Field

The disclosed concept pertains generally to electrical enclosures and, more particularly, to electrical distribution panels, such as load centers or panelboards. The disclosed concept further pertains to neutral busses for neutral bars.

2. Background Information

Electrical distribution panels, such as load centers or panelboards, incorporate a plurality of circuit breakers and provide a safe and controllable distribution of electric power. Such load centers and panelboards have become a common feature in both residential and commercial applications.

Neutral bars provide, for example, a convenient termination location for a plurality of neutral conductors of a plurality of circuit breakers of an electrical distribution panel. The neutral bar is taken to ground or “Earthed” through a neutral-Earth link, which is an electrical connection between the neutral bar and the Earth or a suitable ground.

FIG. 1 shows a pair of neutral bars 2,4 electrically connected by a neutral bus (e.g., without limitation a conductive strap; a conductive bus bar; an aluminum strap) 6. The neutral bus 6 is covered by shrink tubing (not shown) to insulate an intermediate portion 7 of the neutral bus 6 from other components (not shown). In this configuration, a relatively large screw 8 and washer 10 are employed at each end of the neutral bus 6 to electrically and mechanically connect it to a corresponding one of the neutral bars 2,4. The screw 8 and washer 10 occupy space for three neutral bar openings 12 as shown with neutral bar 4. As a result, if a total of twelve neutral bar terminals 14 are desired, then the neutral bars 2,4 must be sized for a total of fifteen neutral bar terminals, which include the three unusable neutral bar openings 12. In this configuration, the neutral bars 2,4 are about 5.338 inches long. If a lug (not shown) is added to one end of the neutral bars 2,4, then the neutral bars 2,4 are about 5.688 inches long.

It is also known to electrically connect one neutral bar to another neutral bar by employing a copper round wire material (not shown) substantially covered by insulative shrink tubing (not shown). It is believed that in this prior proposal, the copper round wire material occupies one neutral bar screw terminal (not shown) on a first neutral bar, and requires two neutral bar screw terminals (not shown) on a second neutral bar since the copper round wire material is routed over and around the second neutral bar.

U.S. Pat. No. 7,864,509 discloses neutral bar assemblies that are directly electrically connected together by a fixed, rigid, conductive strap at a load center, and neutral bar assemblies that can be electrically isolated by removing a field-removable jumper.

There is room for improvement in neutral busses for neutral bars.

There is further room for improvement in electrical distribution panels, which include a neutral bus and neutral bars.

### SUMMARY

These needs and others are met by embodiments of the disclosed concept, which provide, for example, a neutral bus elongated conductor made of a flat material, which is curled to form a curved shape that is structured to be inserted and fastened in one of the openings of a neutral bar.

In accordance with one aspect of the disclosed concept, a neutral bus is for a neutral bar including a plurality of openings and a plurality of corresponding fasteners. The neutral bus comprises: an elongated conductor comprising a first end and an opposite second end, and an insulator substantially covering the elongated conductor, wherein at least one of the first end and the opposite second end is made of a flat material, which is curled to form a curved shape that is structured to be inserted and fastened in one of the openings of the neutral bar.

The elongated conductor may further comprise an elongated intermediate portion between the first end and the opposite second end; and the elongated intermediate portion may be covered by the insulator. The insulator may be disposed on the elongated intermediate portion by an insert molding process.

The insulator may be applied to a substantial portion of the elongated conductor by an insert molding process.

The insulator may be a polyester film insulator folded over a substantial portion of the elongated conductor.

The insulator may be made of thermoplastic material that surrounds and encapsulates a substantial portion of the elongated conductor.

As another aspect of the disclosed concept, a neutral bus for a neutral bar comprises: an elongated conductor comprising a first end and an opposite second end, and an insulator substantially covering the elongated conductor, wherein the insulator is disposed on a substantial portion of the elongated conductor by an insert molding process, and wherein each of the first end and the opposite second end is structured to be electrically connected and mechanically fastened to the neutral bar.

As another aspect of the disclosed concept, a neutral bus for a neutral bar comprises: an elongated conductor comprising a first end and an opposite second end; and a polyester film insulator comprising a first end portion and an opposite second end portion; wherein each of the first end and the opposite second end of the elongated conductor is structured to be electrically connected and mechanically fastened to the neutral bar, wherein the polyester film insulator is folded over a substantial portion of the elongated conductor, in order to substantially cover the elongated conductor, and wherein the first end portion is secured to the opposite second end portion of the polyester film insulator.

The polyester film insulator may further comprise an intermediate portion between the first end portion and the opposite second end portion thereof; the elongated conductor may be an elongated flat conductor having a first side and an opposite second side; the first end portion and the opposite second end portion of the polyester film insulator may extend substantially beyond the first side of the elongated flat conductor; and the intermediate portion of the polyester film insulator may be folded and extend substantially beyond the opposite second side of the elongated flat conductor.

As another aspect of the disclosed concept, an electrical distribution panel comprises: a first neutral bar comprising a plurality of openings; a second neutral bar comprising a plurality of openings; a neutral bus comprising an elongated conductor comprising a first end and an opposite second end; and an insulator substantially covering the elongated conductor, wherein the first end and the opposite second end of the elongated conductor are made of a flat material, which is curled to form a curved shape, wherein the curved shape of the first end of the elongated conductor is inserted in one of the openings of the first neutral bar and coupled thereto by a first fastener, and wherein the curved shape of the opposite second end of the elongated conductor is inserted in one of the openings of the second neutral bar and coupled thereto by a second fastener.

The insulator may be disposed on the elongated intermediate portion by an insert molding process.

The one of the openings of the first neutral bar may be a first single circular opening; the one of the openings of the second neutral bar may be a second single circular opening; the curved shape of the first end of the elongated conductor may be a first rounded shape that is inserted and fastened in the first single circular opening; and the curved shape of the opposite second end of the elongated conductor may be a second rounded shape that is inserted and fastened in the second single circular opening.

The elongated conductor may be substantially insulated by the insulator applied thereto with an insert molding process.

The insulator may be a polyester film insulator folded over a substantial portion of the elongated conductor.

### BRIEF DESCRIPTION OF THE DRAWINGS

A full understanding of the disclosed concept can be gained from the following description of the preferred embodiments when read in conjunction with the accompanying drawings in which:

FIG. 1 is an isometric view of a pair of neutral bars electrically connected by a neutral bus.

FIG. 2 is an isometric view of a pair of neutral bars electrically connected by a neutral bus in accordance with embodiments of the disclosed concept.

FIG. 3 is an isometric view of a pair of neutral bars electrically connected by a neutral bus in which each of the neutral bars includes a lug in accordance with another embodiment of the disclosed concept.

FIG. 4 is an isometric view of a pair of neutral bars electrically connected by a neutral bus in accordance with another embodiment of the disclosed concept.

FIG. 5 is an exploded isometric view of the neutral bus of FIG. 4 including a polyester film insulator.

FIG. 6 is an isometric view of the neutral bus and polyester film insulator of FIG. 5.

FIG. 7 is an end elevation view of the neutral bus and polyester film insulator of FIG. 6.

FIG. 8 is a vertical elevation view of an electrical distribution panel including a pair of neutral bars electrically connected by a neutral bus in accordance with another embodiment of the disclosed concept.

### DESCRIPTION OF THE PREFERRED EMBODIMENTS

As employed herein, the term “number” shall mean one or an integer greater than one (i.e., a plurality).

As employed herein, the statement that two or more parts are “connected” or “coupled” together shall mean that the parts are joined together either directly or joined through one or more intermediate parts. Further, as employed herein, the statement that two or more parts are “attached” shall mean that the parts are joined together directly.

As employed herein, the term “electrical distribution panel” shall mean a load center, a panelboard, or another suitable component of an electricity supply system which divides a main electrical power feed (e.g., without limitation, three-phase; Line1 and Line2) into a number of subsidiary branch circuits, while providing a circuit interrupter (e.g., a protective fuse or circuit breaker) for each branch circuit.

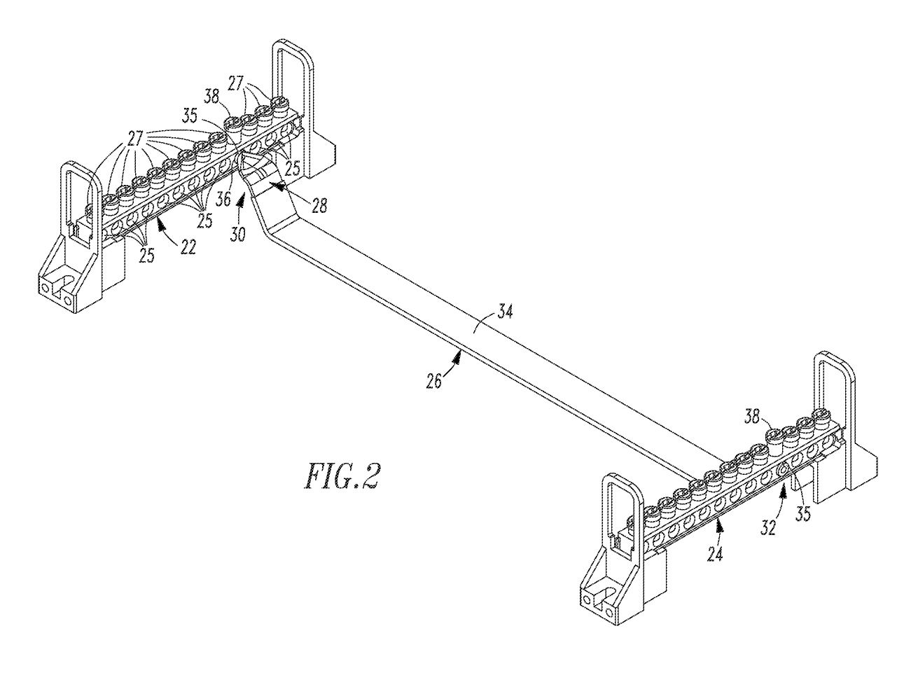

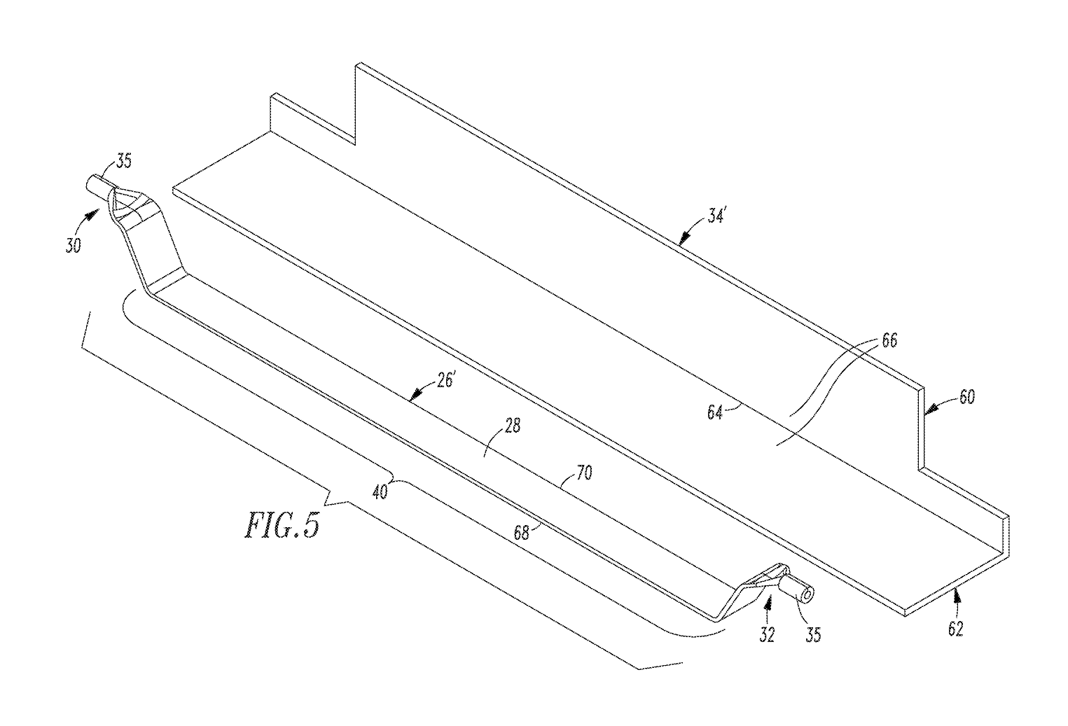

Referring to FIG. 2, a pair of neutral bars 22,24 are electrically connected by a neutral bus 26. The example neutral bus 26 is for a neutral bar, such as 22, including a plurality of openings 25 and a plurality of corresponding fasteners 27. The neutral bus 26 includes an elongated conductor 28 (best shown in FIG. 5 with neutral bus 26′) having a first end 30 and an opposite second end 32, and an insulator 34 (another insulator 34′ is shown in FIG. 5) substantially covering the elongated conductor 28. At least one of the first end 30 and the opposite second end 32 is made of a flat material, which is curled to form a curved shape 35 (best shown in FIG. 5) that is structured to be inserted and fastened in one of the openings, such as 36, of the neutral bar 22.

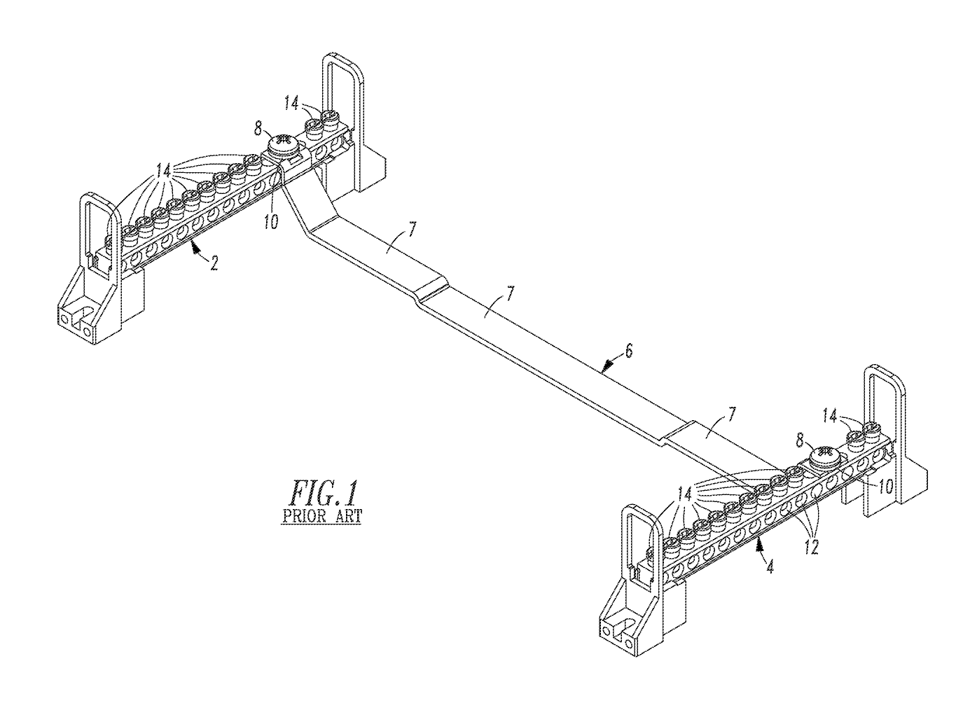

Although FIGS. 2 and 5 show neutral busses 26,26′ having both ends 30,32 with the curved shape 35, the disclosed concept is applicable to neutral bars in which only one of the ends 30,32 has the curved shape 35. In such a configuration, the other end could employ another mechanism (e.g., without limitation, the screw 8, nut 10 and forked end shown in FIG. 1) to electrically and mechanically connect that end to another neutral bar.

### Example 1

As shown in FIG. 2, the curved shape 35 (best shown in FIG. 5 with the elongated conductor 28) of each of the ends 30,32 of the neutral bus 26 is electrically and mechanically connected to the neutral bars 22,24 by a corresponding one of the fasteners, such as the example screws 38 (e.g., without limitation, conventional neutral bar screws). Each of the screws 38 only occupies space for one neutral bar opening. As a result, if a total of twelve neutral bar fasteners 27 are desired for neutral circuits and connection to neutral conductors (not shown) of, for example, corresponding circuit breakers (not shown), then the neutral bars 22,24 are sized for a total of thirteen neutral bar fasteners 27,36, which include the one neutral bar opening for the curved shape 35. In this configuration, the neutral bars 22,24 are about 4.638 inches long. This is about 0.7 inch shorter than the neutral bars 2,4 of FIG. 1.

This configuration employs existing neutral bar openings, such as 25, and screws, such as 38, and only occupies one neutral bar opening at each of the ends 30,32 of the neutral bus 26. By only occupying one neutral bar opening location on each end, the length of the neutral bars 22,24 can be reduced, which reduces cost and the corresponding footprint in an electrical distribution panel (not shown).

### Example 2

As shown with the neutral bus 26′ of FIG. 5, the elongated conductor 28 includes an elongated intermediate portion 40 between the first end 30 and the opposite second end 32. As shown in FIG. 2, the elongated intermediate portion 40 (FIG. 5) is covered by the insulator 34.

### Example 3

The insulator 34 (FIG. 2) is disposed on the elongated intermediate portion 40 (FIG. 5) of the elongated conductor 28 by an insert molding process. Insert molding is cost effective in terms of both material and labor. In the insert molding process, a suitable plastic is injected into a mold (not shown) that contains a pre-placed insert, such as the example elongated conductor 28. The result of insert molding is a single molded plastic piece with a conductive metal insert surrounded by the plastic.

In the disclosed concept, the suitable plastic flows around the elongated intermediate portion 40 of the elongated conductor 28 and hardens. A number of elongated conductors 28 are placed into a multi-cavity injection mold (not shown) and the suitable plastic material is molded around the elongated conductors 28 via a conventional injection molding process. Fully encapsulating the elongated intermediate portion 40 of the elongated conductor 28 with the suitable plastic material provides a suitable mechanical bonding of the two materials.

### Example 4

The elongated conductor 28 is made of a suitably flat aluminum material. The ends 30,32 of the elongated conductor 28 are curled around to be suitably shaped for insertion in a neutral bar opening, such as 25. Flat aluminum material is cheaper to produce than round wire aluminum material, and aluminum is cheaper than copper.

### Example 5

Although aluminum is disclosed, the elongated conductor 28 can be made of any suitable conductor.

### Example 6

As shown in FIG. 2, each of the openings 25 of the neutral bars 22,24 is a single circular opening 25. The curved shape 35 of the ends 30,32 of the elongated conductor 28 is a rounded shape (e.g., having a cylindrical portion externally shaped like a neutral wire) that inserted and fastened in the single circular opening 25 by the screws 38.

### Example 7

The insulator 34 (shown in FIG. 2) is applied to a substantial portion of the elongated conductor 28 (shown in FIG. 5) by an insert molding process.

### Example 8

The insulator 34 is made of thermoplastic material that surrounds and encapsulates a substantial portion of the elongated conductor 28. The thermoplastic material is employed for insulation around the neutral bus 26.

### Example 9

The elongated conductor 28 of FIG. 5 is an elongated aluminum strap.

### Example 10

The insulator 34 is made of a thermoplastic material molded around a substantial portion of the elongated conductor 28.

### Example 11

The elongated conductor 28 is substantially insulated by the insulator 34 applied thereto with an insert molding process.

### Example 12

The insulator 34 is made of thermoplastic material that surrounds and encapsulates a substantial portion of the elongated conductor 28.

### Example 13

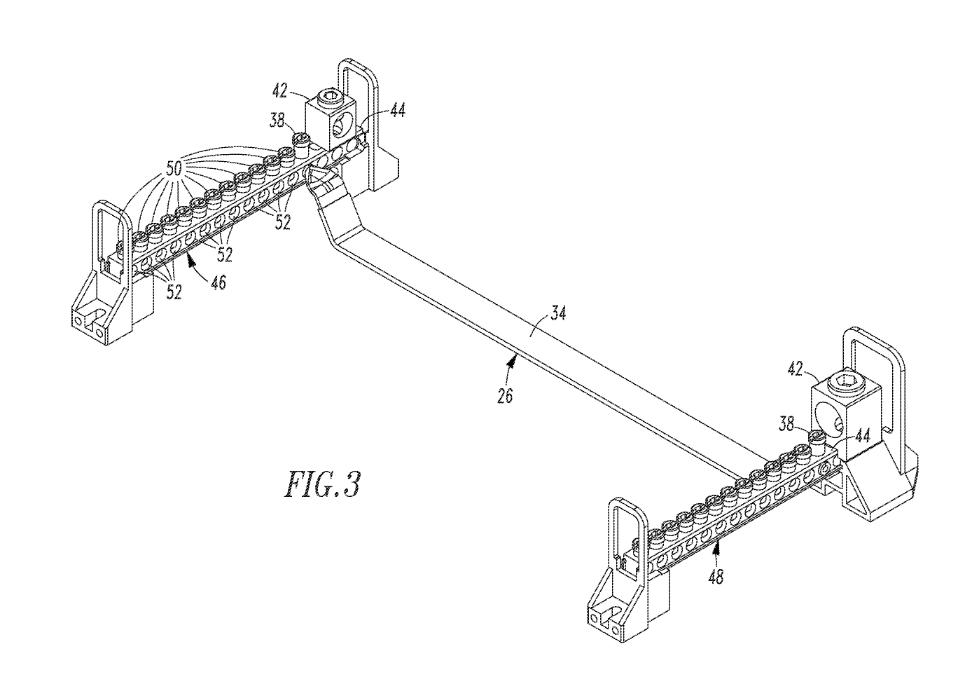

As shown in FIG. 3, a number of lugs 42 are attached to the ends 44 of neutral bars 46,48. This increases the example length of the neutral bars 46,48 to about 5.688 inches long, where there are twelve usable fasteners 50 and twelve corresponding openings 52 as shown with the neutral bar 46. The neutral bus 26 is electrically and mechanically connected to the neutral bars 46,48 by corresponding fasteners, such as the example screws 38.

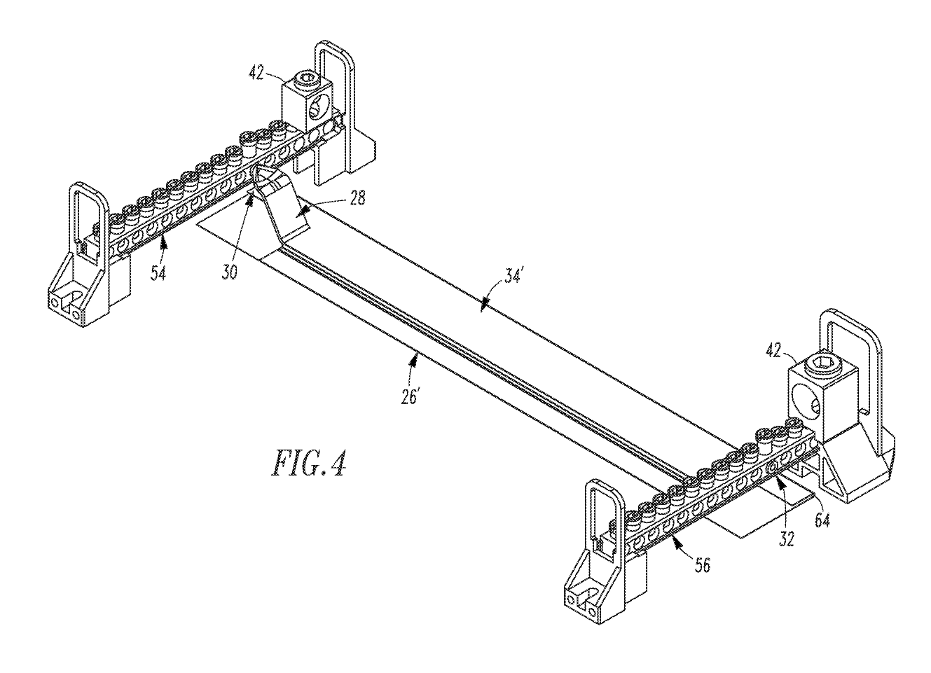

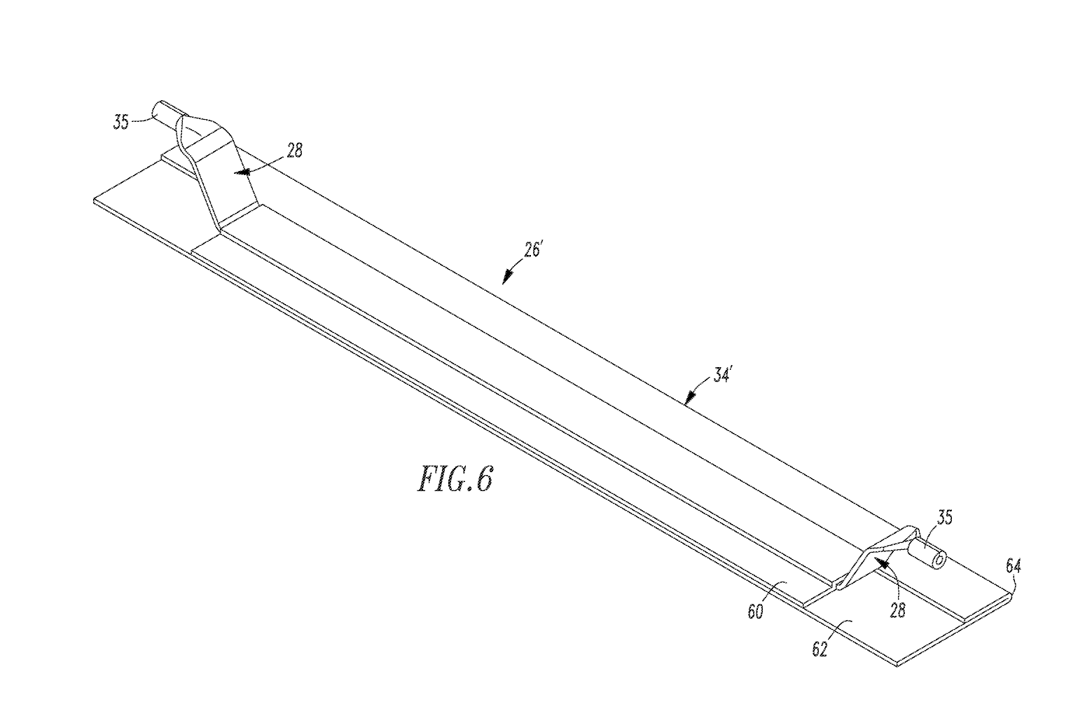

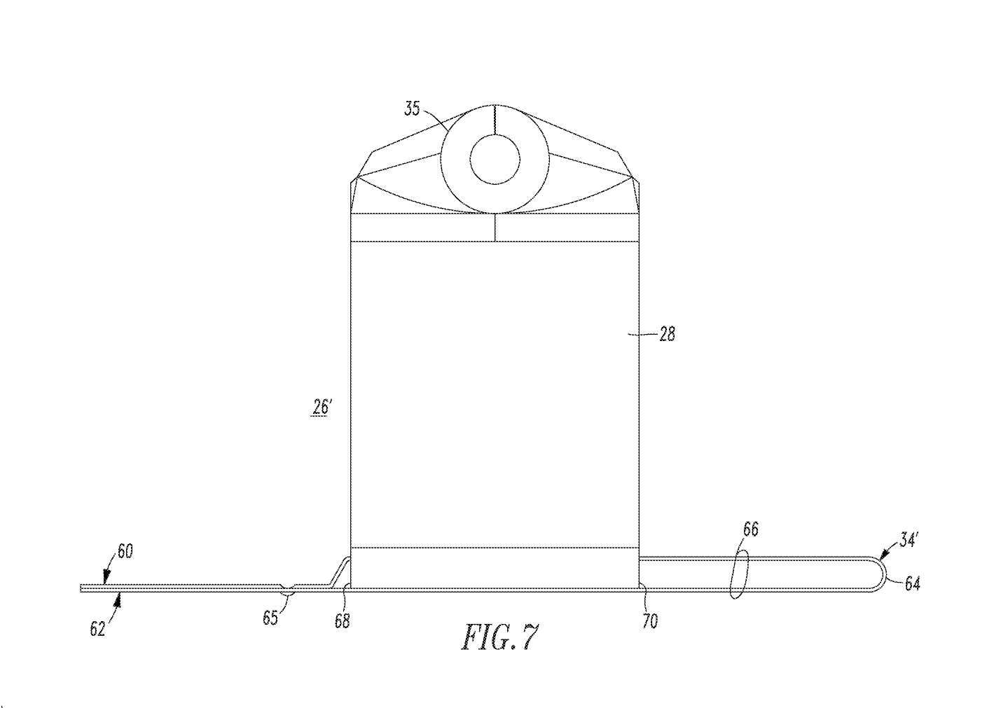

Referring to FIGS. 4-7, a pair of neutral bars 54,56 are electrically connected by the neutral bus 26′, which includes the example polyester film insulator 34′. The example neutral bars 54,56 can be the same as or similar to the neutral bars 46,48 of FIG. 3 and include the lugs 42, as shown, or can be the same as or similar to the neutral bars 22,24 of FIG. 2 and not include the lugs 42. The polyester film insulator 34′ includes a first end portion 60 and an opposite second end portion 62 as are best shown in FIG. 7. Each of the first end 30 and the opposite second end 32 of the elongated conductor 28 (FIGS. 4 and 5) is structured to be electrically connected and mechanically fastened to one of the neutral bars 54,56. The polyester film insulator 34′ is folded, at 64 of FIGS. 4-7, over a substantial portion of the elongated conductor 28, in order to substantially cover the elongated conductor 28. The first end portion 60 is secured to the opposite second end portion 62 of the polyester film insulator 34′ by a number of seals 65 (FIG. 7). Heat and pressure are applied at seals 65 to both portions 60 and 62. The heat and pressure melt the material of these portions 60 and 62 and the material chemically bonds. When the heat and pressure are removed, the material hardens and portions 60 and 62 are mechanically bonded. Seals 65 can be a number of round points or a number of strips along the length of insulator 34′, or seals 65 can be a single strip along the entire length of insulator 34′.

### Example 14

The elongated conductor 28 includes the elongated intermediate portion 40 between the first end 30 and the opposite second end 32 thereof as shown in FIG. 5.

### Example 15

The elongated intermediate portion 40 is covered by the insulator 34′. The polyester film insulator 34′ is folded over a substantial portion of the elongated conductor 28. The example polyester film insulator 34′ (e.g., without limitation, a MYLAR® polyester film) increases costs with respect to the insert molding process of the insulator 34 of FIG. 2 from a material aspect, but reduces labor costs. This option is also less expensive than a shrink tubing insulator in terms of material and labor.

### Example 16

As shown in FIG. 7, the polyester film insulator 34′ includes an intermediate portion 66 between the first end portion 60 and the opposite second end portion 62 thereof. As shown in FIG. 5, the elongated conductor 28 is an elongated flat conductor having a first side 68 and an opposite second side 70. The first end portion 60 and the opposite second end portion 62 of the polyester film insulator 34′ extend substantially beyond the first side 68 of the elongated flat conductor 28 as shown in FIG. 7. Also, the intermediate portion 66 of the polyester film insulator 34′ is folded at 64 and extends substantially beyond the opposite second side 70 of the elongated flat conductor 28. The elongated flat conductor 28 needs to be insulated from enclosure 88 and interior assembly 90. Because insulator 34′ does not cover the angled portion of conductor 28, sufficient over surface clearance needs to be maintained. This means that the electrical current has the potential to travel or “arc” over the surface of insulator 34′ and contact enclosure 88. The amount of voltage limits how far the current can travel over the surface of an insulating material. Insulator 34′ is much wider than conductor 28 because a proper distance must be maintained. In the insert molded example, insulator 34 covers the angled portion of conductor 28 and conductor 28 is exposed at a sufficient distance from enclosure 88.

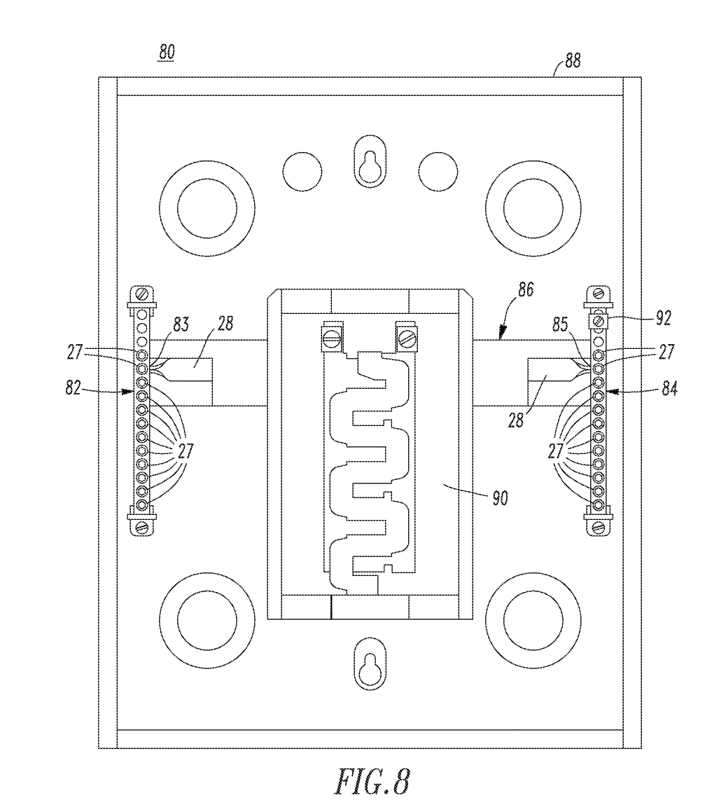

Referring to FIG. 8, an electrical distribution panel 80 includes a pair of neutral bars 82,84 electrically connected by a neutral bus 86. The first neutral bar 82 includes a plurality of openings 83 and the second neutral bar 84 includes a plurality of openings 85. The neutrals bars 82,84 can be the same as or similar to the neutral bars 22,24 of FIG. 2, the neutral bars 46,48 of FIG. 3, or the neutral bars 54,56 of FIG. 4. The neutral bus 86 can be the same as or similar to the neutral bus 26 of FIGS. 2 and 3, or the neutral bus 26′ of FIGS. 4-7.

As shown in FIG. 8, the neutral bus 86 is the same as or similar to the neutral bus 26′ of FIGS. 4-7, with the insulator 34′ substantially covering the elongated conductor 28. In this example, the polyester film insulator 34′ is folded and then sealed together at the seal points 65 (FIG. 7) proximate the first side 68 of the elongated conductor 28. The polyester film insulator 34′ is between the neutral bus 86 and the metal load center enclosure 88 and between the neutral bus 86 and the metal breaker interior assembly 90 in the middle of the electrical distribution panel 80. This insulates the neutral bus 86 from both the metal enclosure 88 and the metal breaker interior assembly 90.

### Example 17

The elongated conductor 28 transfers current from the first neutral bar 82 to or from the second neutral bar 84, while being insulated from ground (not shown, but typically tied to the metal load center enclosure 88).

### Example 18

As shown in FIG. 8, the first neutral bar 82 does not include a lug, while the second neutral bar 84 includes a lug 92. However, the disclosed concept is applicable to neutral bars, which include zero, one or any suitable number of lugs.

### Example 19

The insulators 34,34′ are structured to insulate the elongated conductor 28 from both of a metal enclosure, such as 88, and a metal assembly, such as 90, coupled to an interior portion of the metal enclosure (e.g., as shown with the metal enclosure 88 and metal assembly 90 of FIG. 8).

### Example 20

The insulator 34′ is a polyester film insulator folded over a substantial portion of the elongated conductor 28.

The disclosed concept provides a neutral bus inserted into a neutral bar opening and coupled to the neutral bar with a conventional neutral bar screw. This eliminates the need to remove three conventional neutral bar screws and couple a neutral bus on the top of a neutral bar using a relatively large screw and washer. This enables the length of the neutral bar to be reduced because the disclosed concept employs one neutral opening rather than three neutral openings.

The insulator 34 on the disclosed neutral bus 26 is applied by using insert molding technology and is more cost effective than putting shrink tubing on by hand and shrinking the tubing with heat.

The insulator 34′ on the disclosed neutral bus 26′ is a folded polyester film insulator.

While specific embodiments of the disclosed concept have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the disclosed concept which is to be given the full breadth of the claims appended and any and all equivalents thereof.

What is claimed is:

1. A neutral bus for a neutral bar including a plurality of openings and a plurality of corresponding fasteners, said neutral bus comprising:
an elongated conductor comprising a first end and an opposite second end, and
an insulator substantially covering said elongated conductor,
wherein at least one of the first end and the opposite second end is made of a flat material, which is curled to form a curved shape that is structured to be inserted and fastened in one of the openings of said neutral bar.

2. The neutral bus of claim 1 wherein said elongated conductor further comprises an elongated intermediate portion between the first end and the opposite second end; and wherein said elongated intermediate portion is covered by said insulator.

3. The neutral bus of claim 2 wherein said insulator is disposed on said elongated intermediate portion by an insert molding process.

4. The neutral bus of claim 1 wherein said elongated conductor is made of a flat aluminum material.

5. The neutral bus of claim 1 wherein said at least one of the first end and the opposite second end is both of the first end and the opposite second end.

6. The neutral bus of claim 1 wherein said one of the openings of said neutral bar is a single circular opening; and wherein said curved shape is a rounded shape that is structured to be inserted and fastened in said single circular opening.

7. The neutral bus of claim 1 wherein said insulator is applied to a substantial portion of said elongated conductor by an insert molding process.

8. The neutral bus of claim 1 wherein said insulator is a polyester film insulator folded over a substantial portion of said elongated conductor.

9. The neutral bus of claim 1 wherein said insulator is made of thermoplastic material that surrounds and encapsulates a substantial portion of said elongated conductor.

10. The neutral bus of claim 1 wherein said elongated conductor is an elongated aluminum strap.

11. A neutral bus for a neutral bar, said neutral bus comprising:
an elongated conductor comprising a first end and an opposite second end, and
an insulator substantially covering said elongated conductor,
wherein said insulator is disposed on a substantial portion of said elongated conductor by an insert molding process, and
wherein each of the first end and the opposite second end is structured to be electrically connected and mechanically fastened to said neutral bar.

12. The neutral bus of claim 11 wherein said insulator is made of a thermoplastic material molded around the substantial portion of said elongated conductor.

13. A neutral bus for a neutral bar, said neutral bus comprising:
an elongated conductor comprising a first end and an opposite second end; and
a polyester film insulator comprising a first end portion and an opposite second end portion;
wherein each of the first end and the opposite second end of said elongated conductor is structured to be electrically connected and mechanically fastened to said neutral bar,
wherein said polyester film insulator is folded over a substantial portion of said elongated conductor, in order to substantially cover said elongated conductor, and
wherein the first end portion is secured to the opposite second end portion of said polyester film insulator.

14. The neutral bus of claim 13 wherein said polyester film insulator further comprises an intermediate portion between the first end portion and the opposite second end portion thereof; wherein said elongated conductor is an elongated flat conductor having a first side and an opposite second side; wherein the first end portion and the opposite second end portion of said polyester film insulator extend substantially beyond the first side of said elongated flat conductor; and wherein the intermediate portion of said polyester film insulator is folded and extends substantially beyond the opposite second side of said elongated flat conductor.

15. An electrical distribution panel comprising:
a first neutral bar comprising a plurality of openings;
a second neutral bar comprising a plurality of openings;
a neutral bus comprising an elongated conductor comprising a first end and an opposite second end; and
an insulator substantially covering said elongated conductor,
wherein the first end and the opposite second end of said elongated conductor are made of a flat material, which is curled to form a curved shape,
wherein the curved shape of the first end of said elongated conductor is inserted in one of the openings of the first neutral bar and coupled thereto by a first fastener, and
wherein the curved shape of the opposite second end of said elongated conductor is inserted in one of the openings of the second neutral bar and coupled thereto by a second fastener.

16. The electrical distribution panel of claim 15 wherein said elongated conductor transfers current from the first neutral bar to the second neutral bar.

17. The electrical distribution panel of claim 15 wherein said electrical distribution panel is a load center.

18. The electrical distribution panel of claim 15 wherein said electrical distribution panel is a panelboard.

19. The electrical distribution panel of claim 15 wherein said elongated conductor further comprises an elongated intermediate portion between the first end and the opposite second end thereof.

20. The electrical distribution panel of claim 19 wherein said elongated intermediate portion is covered by said insulator.

21. The electrical distribution panel of claim 20 wherein said insulator is disposed on said elongated intermediate portion by an insert molding process.

22. The electrical distribution panel of claim 15 wherein said one of the openings of the first neutral bar is a first single circular opening; wherein said one of the openings of the second neutral bar is a second single circular opening; wherein said curved shape of the first end of said elongated conductor is a first rounded shape that is inserted and fastened in said first single circular opening; and wherein said curved shape of the opposite second end of said elongated conductor is a second rounded shape that is inserted and fastened in said second single circular opening.

23. The electrical distribution panel of claim 15 wherein said elongated conductor is substantially insulated by said insulator applied thereto with an insert molding process.

24. The electrical distribution panel of claim 15 wherein said insulator is made of thermoplastic material that surrounds and encapsulates a substantial portion of said elongated conductor.

25. The electrical distribution panel of claim 15 wherein at least one of said first neutral bar and said second neutral bar comprises two ends and a number of lugs disposed at or about one or both of the two ends.

26. The electrical distribution panel of claim 15 wherein said insulator is structured to insulate said elongated conductor from both of a metal enclosure and a metal assembly coupled to an interior portion of said metal enclosure.

27. The electrical distribution panel of claim 15 wherein said insulator is a polyester film insulator folded over a substantial portion of said elongated conductor.
